(19) United States
(12) Patent Application Publication
(10) Pub. No.: US 2026/0295778 A1
(43) Pub. Date: Oct. 1, 2026

(54) HAND-OPERATED IMPLEMENT WITH CONTROLLABLE HAND GRIP ROTATION

(71) Applicant: Caitlyn Lilly, Tallmadge, OH (US)

(72) Inventor: Caitlyn Lilly, Tallmadge, OH (US)

(21) Appl. No.: 19/576,397

(22) Filed: Mar. 24, 2026

Related U.S. Application Data
(60) Provisional application No. 63/778,731, filed on Mar. 27, 2025.
(60) Provisional application No. 63/860,164, filed on Aug. 8, 2025.

(51) Int. Cl. B25B 7/12; A41G 5/00; B25B 7/08

(52) U.S. Cl. CPC B25B 7/12; A41G 5/0086; B25B 7/08

(57) ABSTRACT

A hand-operated implement or tool, preferably cosmetic pliers in one embodiment, having controllable hand grip rotation. The implement includes a first tool member connected to a second tool member via a pivot which allows a first tool head of the first tool member to be selectively engaged with a second tool head of the second tool member. The tool members have respective handles, wherein at least one of the handles includes a handle cover functioning as a hand grip. A tension system operatively connects the first handle cover to a first shaft of the first handle to selectively control or even prevent rotation of the handle cover in relation to the first shaft. The construction allows the hand-operated implement to be custom-tailored with respect to hand grip rotation desired by an individual user.

### CROSS-REFERENCE

This application claims the priority filing dates of U.S. Provisional Application Ser. No. 63/778,731 filed Mar. 27, 2025 and U.S. Provisional Application Ser. No. 63/860,164 filed Aug. 8, 2025, herein fully incorporated by reference.

### FIELD OF THE INVENTION

The present invention relates to a hand-operated implement or tool, preferably cosmetic pliers in one embodiment, having controllable hand grip rotation. The implement includes a first tool member connected to a second tool member via a pivot which allows a first tool head of the first tool member to be selectively engaged with a second tool head of the second tool member. The tool members have respective handles, wherein at least one of the handles includes a handle cover functioning as a hand grip. A tension system operatively connects the first handle cover to a first shaft of the first handle to selectively control or even prevent rotation of the handle cover in relation to the first shaft. The construction allows the hand-operated implement to be custom-tailored with respect to hand grip rotation desired by an individual user.

### BACKGROUND OF THE INVENTION

Hand-operated tools and implements typically include two handles and are designed to be used with either one or two hands. Depending upon intended end uses, handles have been provided with a myriad of configurations. Typically, implements have a pair of tool members that are pivotably connected at a pivot point with the handles being used to move opposing tool heads in and out of contact with each other to accomplish a particular task. Implements may be provided with levers and/or gears that transmit and increase a force from the handles to the tool head or jaws in some embodiments. Implements may also be provided with springs or other devices that bias opposing tool heads away from each other. In order to accomplish certain tasks, some hand-operated tools and implements have been provided with handles having rotatable features.

Some examples of prior art implements follow.

U.S. Patent Application Publication 2003/0014868 relates to a two-handed cutting tool comprising a first cutting element and a second cutting element. The first cutting element includes a first handle coupled to a first blade and the second cutting element includes a second handle coupled to a second blade. The first and second cutting element are coupled together so that the first and second blades are actuable between an open position and a closed position when the handles are operated towards and away from each other in an operating plane. At least a portion of the first handle is rotatable about an axis extending in the operating plane.

U.S. Pat. No. 6,842,983 relates to a pair of gardening shears including two expandable handles, each handle being formed of an oval outer tube, an oval inner tube, and a grip rotatably fastened to the lower end of the outer tube. The inner tube is slidably fitted at the lower end into the upper end of the outer tube in conjunction with a locating structure including a threaded rod fastened at the lower end to the grip, an upper arresting block, a lower arresting block, and a spring located between the two arresting blocks, which are actuated by the threaded rod to arrest the inner tube at the time when the grip is turned counterclockwise. The inner tube is relieved of the pressures exerting thereon by the two arresting blocks at the time when the grip is tuned clockwise.

U.S. Patent Application Publication 2008/0216326 relates to a multipurpose tool including a tool such as pruning shear in which one handle includes a storage cavity to hold folding tool elements. That handle is rotatable about a longitudinal axis, between a position in which it presents comfortable outer surfaces to be gripped during use of the pruning shear, and a position exposing the folding tool elements to be extended. A blade latch release lever for releasing the folding tool elements may include grip ears located at the sides of the main handle.

WO2014/081090 relates to agricultural scissors reportedly enabling a user to freely use both hands even in a state in which the user grasps the scissors without removing the scissors from the hands of the user. The agricultural scissors comprise: a pair of operating parts including a blade portion and a grip portion so as to rotatably connect to each other in an “X” shape by a hinge such that a pair of blade portions can be crossed; a first handle part fixedly provided to the grip portion formed by one operating part among the pair of operating parts; a second handle part rotatably provided to the grip portion formed by the operating part not provided by the first handle part; and a fixing member connected to the second handle part such that a hand of the user can be inserted between the second handle part and the fixing member.

U.S. Patent Application Publication 2015/0135914 relates to a hand operated cutting tool including a first cutting member; a first handle including a second cutting member, wherein the second cutting member is coupled to the first cutting member and includes a first set of projections; and a second handle including a lever, wherein the lever is coupled to the first cutting member and includes a second set of projections. The first and second handles are movable between a full open position and a full closed position, wherein during a first region of travel proximate the full open position, the first and second set of projections are disengaged, and during a second region of travel proximate the full closed position, the first and second set of projections are at least partly engaged.

EP3072386 relates to the cutting tool operable with two hands only comprising:-a tool head comprising a cutting jaw formed by first and second cutting elements articulated relative to each other;-first and second handling handles of the tool head comprising, at a first end, a grip and, at a second end opposite the first, the first and second cutting elements respectively, for at least one of the first and second handling handles, the handle is mounted free to rotate partly along a longitudinal axis of the handle relative to the cutting element associated with the handling handle in question.

### SUMMARY OF THE INVENTION

The hand-operated tools and implements of the present invention advantageously include a hand grip that is selectively rotatable about a longitudinal axis of the grip due to the inclusion of a tension system that can alternatively fix the hand grip against rotation or selectively allow rotation on application of a minimum amount of rotational force to the outer surface of the hand grip. The construction of the implements of the invention can be tailored to the needs or wants of an individual user. For example, one operator may desire a hand grip that is non-rotatable, in which case the tension system increases tension between a handle cover and a handle shaft, wherein movement between the two is prevented. Another user may prefer free rotation between a handle cover and a handle shaft whereby the tension system is adjusted to a position where the handle cover is secured to the handle shaft, but does not substantially interfere with rotation between rotation of the handle cover in relation to the shaft, i.e. a minimal force is applied by the tension system.

In a further aspect or embodiment, the tension system is completely located and recessed within the handle cover in order to provide an aesthetically pleasing tool or implement.

In still another aspect or embodiment, the tension system can be accessed from a lower end of the handle cover and adjusted utilizing a single tool, for example a key such as a socket mateable with a nut of the tension system.

In a further aspect or embodiment, the tension system is substantially infinitely adjustable to provide variable rates of rotation of the handle cover in relation to the shaft upon application of different amounts of rotational force to the outer surface of the handle cover.

In one aspect or embodiment, a hand-operated implement with controllable hand grip rotation is disclosed, comprising a first tool member pivotally connected to a second tool member via a pivot, wherein the first tool member includes a first tool head at an upper end and a first handle at a lower end on an opposite side of the pivot, wherein the second tool member includes a second tool head at an upper end and a second handle at a lower end on an opposite side of the pivot, wherein the first handle includes a first shaft having a longitudinal length between a first upper end and a second lower end of the first shaft, a first handle cover, and a first tension system, wherein the first handle cover has a longitudinal length and is disposed over at least a portion of the first shaft, and wherein the first tension system operatively connects the first handle cover to the first shaft, with the tension system being adjustable to place at least three different amounts of force between the first shaft and the first handle cover such that the first handle cover can be either fixed against rotation or rotatable in relation to the first shaft upon application of a minimum amount of rotational force to the outer surface of the first handle cover.

In a further aspect or embodiment, a first shaft stop is present on the first shaft between the first upper end and the second lower end, wherein the tension system operatively presses a portion of the first handle cover against the first shaft stop to produce one of the at least three different amounts of force between the first shaft and the first handle cover.

In an additional aspect or embodiment, the first shaft stop is located closer to the first lower end of the first shaft as compared to the second upper end.

In yet a further aspect or embodiment, the second lower end of the first shaft is threaded, wherein the tension system includes a nut, wherein the nut is adjustably connected to threads of the first shaft.

Still another aspect or embodiment, the first tension system further includes a washer disposed on the threaded part of the first shaft above the nut.

In a further aspect or embodiment, the first handle cover comprises a tube, wherein the first handle cover has a first upper end and a second lower end, and wherein the second lower end of the first handle cover extends past the second lower end of the first shaft.

In an additional aspect or embodiment, a first handle cover stop is present on an inner surface of the tube is in contact with the tension system.

In yet a further aspect or embodiment, the nut is located in a recess of the first handle cover, and wherein the nut is a lock nut.

Still another aspect or embodiment, the first shaft stop is cylindrical and has an outer diameter greater than a largest outer diameter of the first shaft.

In a further aspect or embodiment, the second handle includes a second shaft having a longitudinal length between a second upper end and a second lower end of the second draft, a second handle cover, and a second tension system, wherein the second handle cover has a longitudinal length and is disposed over at least a portion of the second shaft, and wherein the second tension system operatively connects the second handle cover to the second shaft, with the tension system being adjustable to place at least three different amounts of force between the second shaft and the second handle cover such that the second handle cover can be either fixed against rotation or rotatable in relation to the second shaft upon application of a minimum amount of rotational force to the outer surface of the second handle cover.

In an additional aspect or embodiment, a second shaft stop is present on an outer surface of the second shaft between the second upper end and the second lower end, wherein the tension system presses a portion of the second handle cover against the second shaft stop to produce one of the at least three different amounts of force between the second shaft and the second handle cover.

In a further aspect or embodiment, wherein each of the first handle cover and second handle cover one independently adjustable rotation-wise via the respective first and second tensioning systems.

In a further aspect or embodiment, the second lower end of the first shaft has a threaded bore, wherein the tension system includes a fastener, wherein the fastener is adjustably connected to the threaded bore of the first shaft.

In an additional aspect or embodiment, the fastener comprises a head and at least a partially threaded shaft connected to the head, wherein the shaft fastener mateably connects via intermeshing threads with the threaded bore to operatively connect a first handle cover to the first shaft.

Still another aspect or embodiment, a face surface of the head of the fastener opposite a surface of the head connected to the shaft comprises a recess for a tool that mateably fits the recess so that the tool can rotate the fastener to tighten or loosen the fastener of the tension system, wherein the fastener can be tightened such that the tension system is substantially infinitely adjustable to provide variable rates of rotation of the handle cover or no rotation in relation to the shaft upon application of different amounts of rotational force to the outer surface of the handle cover.

In a further aspect or embodiment, the tension system can be adjusted by the fastener to operatively press a portion of the first handle cover against the first shaft stop to produce one of the at least three different amounts of force between the first shaft and first handle cover.

In an additional aspect or embodiment, the first handle cover has a first handle cover stop having an outer surface adapted to abut the surface of the fastener connected to the shaft, and wherein when the fastener is tightened the head of the fastener presses the first handle cover stop outer surface which presses the first handle cover against the first shaft stop.

Still another aspect or embodiment, the first handle cover stop is recessed within the first handle cover so that the face surface of the fastener it is locatable flush or recessed within the first handle cover.

In another aspect or embodiment, a method for adjusting hand grip rotation on a hand-operated implement is disclosed, comprising the steps of: obtaining the hand-operated implement; and adjusting the tension system to place a first amount of force between the first shaft and the first handle cover so that the first handle cover can be either fixed against rotation or rotatable in relation to the first shaft upon application of a first amount of rotational force to the outer surface of the first handle cover.

In a further aspect or embodiment, a kit is disclosed, comprising the hand-operated implement, and a key for adjusting the tension system.

For the avoidance of doubt, it is understood that while various embodiments or aspects of the invention are described individually, it should be clear that two or more embodiments or aspects can be, and often times are, present in a single device according to the present invention.

### BRIEF DESCRIPTION OF THE DRAWINGS

The invention will be better understood and other features and advantages will become apparent by reading the detailed description of the invention, taken together with the drawings, wherein:

FIG. 1 is a side view showing one embodiment of a hand-operated implement of the present invention including a handle cover rotatable in relation to a shaft, wherein portions of the handle cover are cut away to show the shaft and tension system;

FIG. 2 is a side view showing an alternative embodiment of a handle of a hand-operated implement of the present invention including a handle cover rotatable in relation to a shaft, wherein portions of the handle cover are cut away to show the shaft and tension system;

FIG. 3 is a cross-sectional side view of one embodiment of a first handle of an implement of the present invention including a handle cover, shaft and tension system in the rotatable position;

FIG. 4 is a cross-sectional side view of a further embodiment of a first handle of an implement of the present invention including a handle cover, shaft and tension system in the fixed against rotation position;

FIG. 5 is a perspective view of one embodiment of key for adjusting the tension system of the hand-operated implement and an example of a tensioner mateable therewith;

FIG. 6 is an exploded view of FIG. 2.;

FIG. 7 is a side view of a fastener of an alternative embodiment; and

FIG. 8 is a top view of a fastener of an alternative embodiment.

### DETAILED DESCRIPTION OF THE INVENTION

This description of preferred embodiments is to be read in connection with the accompanying drawings, which are part of the entire written description of this invention. In the description, corresponding reference numbers are used throughout to identify the same or functionally similar elements. Relative terms such as “horizontal,” “vertical,” “up,” “upper”, “down,” “lower”, “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and are not intended to require a particular orientation unless specifically stated as such. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship.

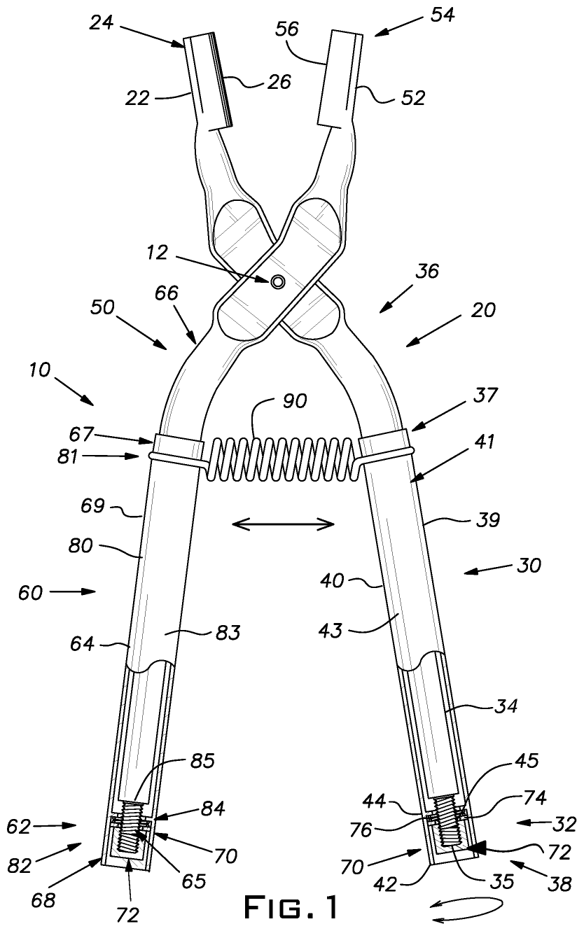

Referring now to the drawings wherein identical or like parts are represented by the same reference numbers throughout the several views, FIG. 1 illustrates a hand-operated implement 10 of the present invention including a first handle cover 40 rotatable in relation to a first shaft 34, wherein portions of the implement 10 underneath the first handle cover 40 are shown in dashed lines. Implement 10 has a first tool member 20 pivotally connected to a second tool member 50 via a pivot 12. Pivot 12 can be formed having generally any structure known in the art. For example, suitable pivot components include a pin, axle, shaft or the like which hingedly and operatively allow first tool member 20 and second tool member 50 to rotate in relation to each other about a pivot point axis.

First tool member 20 includes a first tool head 22 at an upper end 24 and a first handle 30 at a lower end 32 on an opposite side of the pivot 12. Second tool member 50 includes a second tool head 52 at an upper end 54 and a second handle 60 at a lower end 62 on an opposite side of the pivot 12.

Tool heads 22, 52 as illustrated have complimentary shaped teeth 26, 56 which mate when handles 30 and 60 are squeezed together. It should be clear to one of ordinary skill in the art that tool heads of other configurations can be utilized, for example blades which may bypass each other when the implement handles are squeezed together or otherwise brought closer to each other.

In the embodiment illustrated, the tool heads 22, 52 are particularly useful for cosmetic purposes and particularly preferred for removing keratin bonded hair extensions from the hair.

First handle 30 includes a first shaft 34 having a longitudinal length between a first upper end 36 and a second lower end 38. A first handle cover 40 is positioned over at least a portion of the first shaft 34 and is coextensive longitudinally therewith along a length of the first handle 30. A first tension system 70 is operatively connectable to the first handle 30.

At least a portion of first shaft 34 is cylindrical along a length thereof. In a preferred embodiment, the second lower end 38 of the first shaft 34 has a threaded end 35. The radial outer ends of the threads measured perpendicular to the longitudinal length or direction of the first shaft 34 are located within the radius of the shaft where the threaded end 35 is present on the shaft. Stated in another manner, the maximum radius or diameter of threaded end 35 is smaller than the radius of first shaft 34 at the location where threaded end 35 meets the unthreaded cylindrical portion of first shaft 34. The configuration provides ample space for the tension system 70 to be located within first handle cover 40 as described further herein. First shaft 34 is provided with a first shaft stop 37 preferably closer to the upper end 36 of first shaft 34 as compared to second lower end 38. The first shaft stop 37 has a face surface perpendicular to the longitudinal direction of the first shaft 34 as illustrated in FIG. 1. However, it is to be understood that other configurations such as angled surfaces could be utilized. In a highly preferred embodiment, a first shaft stop 37 has an outer diameter or radius that is greater than a maximum outer diameter or radius of first shaft 34, for example as illustrated in FIG. 1.

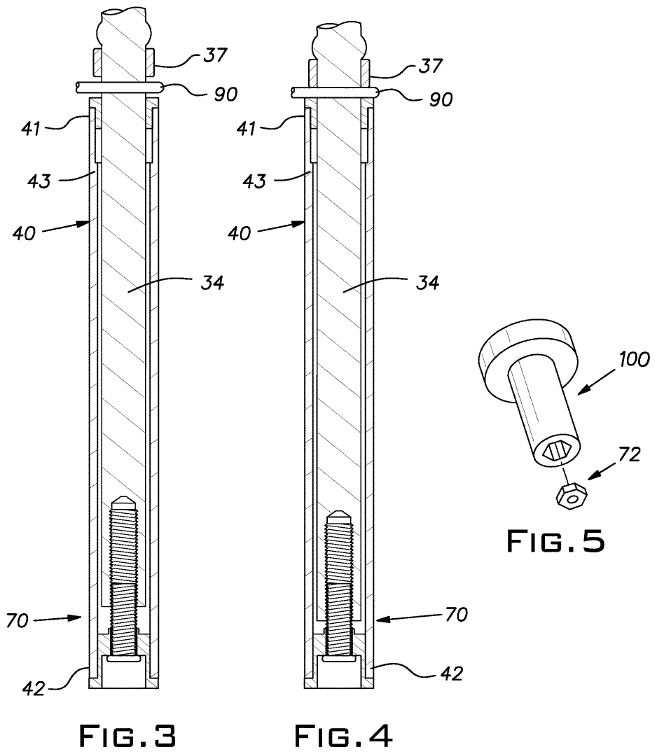

First handle cover 40 has an upper end 41 and a lower end 42. In a preferred embodiment, as illustrated in FIG. 3, with the shaft and tensioner in the rotatable position, the first handle cover 40 is formed as a tube having an inner diameter 43 greater than an outer diameter 39 of first shaft 34 so that the first handle cover 40 can be disposed over first shaft 34 along at least a longitudinal distance of the first shaft 34 and be able to selectively rotate or be fixed in relation thereto, with the shaft and tensioner in the fixed against rotation position, as shown in FIG. 4. The second lower end 42 of the first handle cover 40 extends downwardly past the second lower end 38 of first shaft 34 thereby hiding from sight at least a portion of the first shaft 34 recessed within the first handle cover 40. First handle cover 40 has a first handle cover stop 44 located within the handle cover, preferably at a lower end thereof. First handle cover stop 44 includes an aperture 45 through which a portion of the first shaft 34 extends, namely at least first threaded end 35. The first handle cover stop 44 is configured such that it can be abutted or pressed against a portion of tension system 70. The handle cover stop 44 is directly contacted by a portion of the tension system 70 which in turn operatively urges the first handle cover 40 into contact with the first shaft stop 37, directly or indirectly. An indirect connection is shown in FIG. 1 as a portion of spring 90 is interposed between upper end 41 of first handle cover 40 and the lower face surface of first shaft stop 37. First handle cover stop 44 is preferably in the form of an annulus or cylinder having an inner diameter which is less than an inner diameter of the first handle cover 40 at the lower end 42 thereof. The outer diameter of the first handle cover stop 44 is connected or otherwise fixed to the inner surface of first handle cover 40.

The first tension system 70 operatively connects the first handle cover 40 to the first shaft 34. The tension system 70 is adjustable to place at least three different amounts of force between the first shaft 34 and the first handle cover 40 such that the first handle cover 40 can be either fixed against rotation or rotatable in relation to the first shaft 34 upon application of a minimum amount of rotational force to the outer surface of the first handle cover 40. The tension system includes a tensioner 72, preferably a nut, adjustably threadable to threaded end 35 of first shaft 34. In particular, tensioner 72 when tightened presses against handle cover stop 44 which urges first handle cover 40 towards first shaft stop 37. The greater the force between the first handle cover 40 towards first shaft stop 37, the more difficult rotation becomes between first shaft 34 and first handle cover 40. When sufficient torque is applied to tensioner 72, rotation of first handle cover 40 about first shaft 34 is completely prevented.

In some embodiments, tension system 70 includes tensioner 72 in the form of a lock nut whereby the nut can be fixed against rotation on threaded end 35 of first shaft 34. In still additional embodiments, tension system 70 is provided with a washer 74 is interposed between a face surface of tensioner 72 and a lower surface of handle cover stop 44 to aid in controlling desired rotation. In one embodiment the washer is a lock washer or split ring or the like.

Optionally, the tension system 70 includes a spring 76 which can be interposed between tensioner 72 and first handle cover stop 44 in order to urge the first handle cover 40 directly or indirectly against first shaft stop 37, as illustrated in FIG. 1.

In a similar manner, at least a portion of second shaft 64 is cylindrical along a length thereof. In a preferred embodiment, as illustrated in FIG. 1, the second lower end 68 of the second shaft 64 has a threaded end 65. The radial outer ends of the threads measured perpendicular to the longitudinal length or direction of the second shaft 64 are located within the radius of the shaft where the threaded end 65 is present on the shaft. Stated in another manner, the maximum radius or diameter of threaded end 65 is smaller than the radius of second shaft 64 at the location where threaded end 65 meets the unthreaded cylindrical portion of second shaft 64. The configuration provides ample space for a second tension system 70 to be located within second handle cover 80 as described further herein. Second shaft 64 is provided with a second shaft stop 67 preferably closer to the upper end 66 of the second shaft 64 as compared to the second lower end 68. The second shaft stop 67 has a face surface perpendicular to the longitudinal direction of the second shaft 64 as illustrated in FIG. 1. However, it is to be understood that other configurations such as angled surfaces could be utilized. In a highly preferred embodiment, a second shaft stop 67 has an outer diameter or radius that is greater than a maximum outer diameter or radius of second shaft 67, for example as illustrated in FIG. 1.

Second handle cover 80 has an upper end 81 and a lower end 82. In a preferred embodiment, the second handle cover 80 is formed as a tube having an inner diameter 83 greater than an outer diameter 69 of second shaft 64 so that the second handle cover 80 can be disposed over second shaft 64 along at least a longitudinal distance of the second shaft 64 and be able to selectively rotate or be fixed in relation thereto. The second lower end 82 of the handle cover 80 extends downwardly past the second lower 68 end of second shaft 64 thereby hiding from sight at least a portion of the second shaft 64 recessed within the second handle cover 80. Second handle cover 80 has a second handle cover stop 84 located within the handle cover, preferably at a lower end thereof. Second handle cover stop 84 includes an aperture 85 through which a portion of the second shaft 64 extends, namely at least second threaded end 65. The second handle cover stop 84 is configured such that it can be abutted or pressed against a portion of tension system 70. The second handle cover stop 84 is directly contacted by a portion of the tension system 70 which in turn operatively urges the second handle cover 80 into contact with the second shaft stop 67, directly or indirectly. An indirect connection is shown in FIG. 1 as a portion of spring 90 is interposed between upper end 81 of second handle cover 80 and the lower face surface of second shaft stop 67. Second handle cover stop 84 is preferably in the form of an annulus or cylinder having an inner diameter which is less than an inner diameter which is less than an inner diameter of the second handle cover 80 at the lower end 82 thereof. The outer diameter of the second handle cover stop 84 is connected or otherwise fixed to the inner surface of second handle cover 80. The outer diameter of the second handle cover stop 84 is connected or otherwise fixed to the inner surface of second handle cover 80.

The second tension system 70 operatively connects the second handle cover 80 to the second shaft 64. The tension system 70 is adjustable to place at least three different amounts of force between the second shaft 64 and the second handle cover 80 such that the second handle cover 80 can be either fixed against rotation or rotatable in relation to the second shaft 64 upon application of a minimum amount of rotational force to the outer surface of the second handle cover 80. The tension system includes a tensioner 72, preferably a nut, adjustably threadable to threaded end 65 of second shaft 64. In particular, tensioner 72 when tightened presses against second handle cover stop 84 which urges second handle cover 80 towards second shaft stop 67. The greater the force between the second handle cover 80 towards second shaft stop 67, the more difficult rotation becomes between second shaft 64 and second handle cover 80. When sufficient torque is applied to tensioner 72, rotation of second handle cover 80 about second shaft 64 is completely prevented.

The tension washer/nut can be fully removed to allow the handle cover to be fully removed, whereby the implement or tool can be used without any handle cover at all, if desired. This gives the user three choices for their grip preference.

In a further embodiment of the invention, a kit is disclosed, comprising the hand-operated implement described herein and a key 100 for manipulating tensioner 72, shown in FIG. 5. Key 100 is sized so that it fits within the recess of the handle cover and is able to mate with tensioner 72 therein. The key can tighten or loosen tensioner 72 so that the tensioner can provide the appropriate force between the first shaft and the first handle cover such that the handle cover can be either fixed against rotation or rotationable in relation to the first shaft upon application of a minimum amount of rotational force through the outer surface of the first handle cover 40.

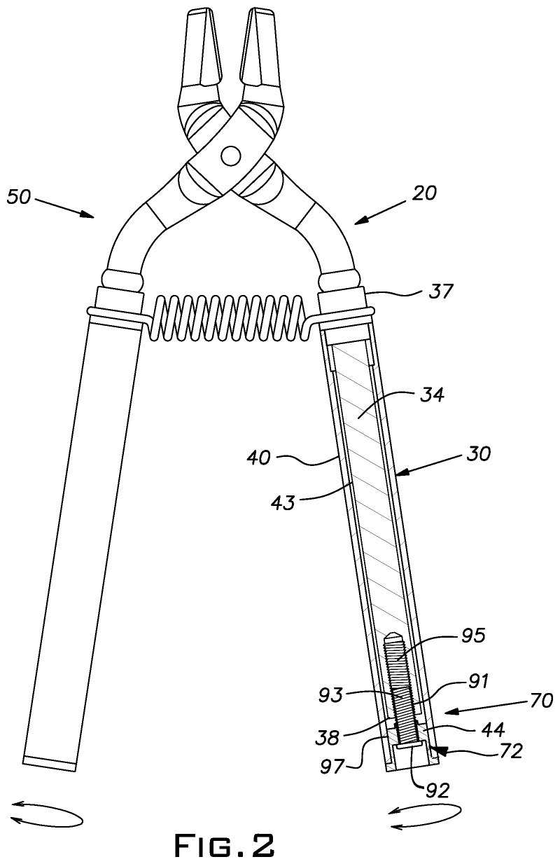

A further embodiment of an alternative tension system for operatively connecting a handle cover to a first shaft of a hand-operated implement as illustrated in FIG. 2. The structure illustrated is also capable of being adjustable to place at least three different amounts of force between the shaft and handle cover such that the handle cover can be fixed against rotation or rotatable in relation to the shaft upon application of a minimum amount of rotational force to the outer surface of the handle cover. The second lower end 38 of the first shaft 34 has a threaded bore 95. A fastener 91 is adjustably connected to, i.e. threadable in, the threaded bore 95 of the first shaft 34, as illustrated in FIG. 2.

FIG. 6 shows an exploded view of FIG. 2.

The fastener 91 comprises a head 92 and at least a partially threaded pin or shaft 93 that mateably connects via the intermeshing threads 98 with the threaded bore 95 to operatively connect a first handle cover 40 to the first shaft 34 with variable tension.

It should be understood by one of ordinary skill in the art that the fastener can be a bolt, screw or an equivalent thereof.

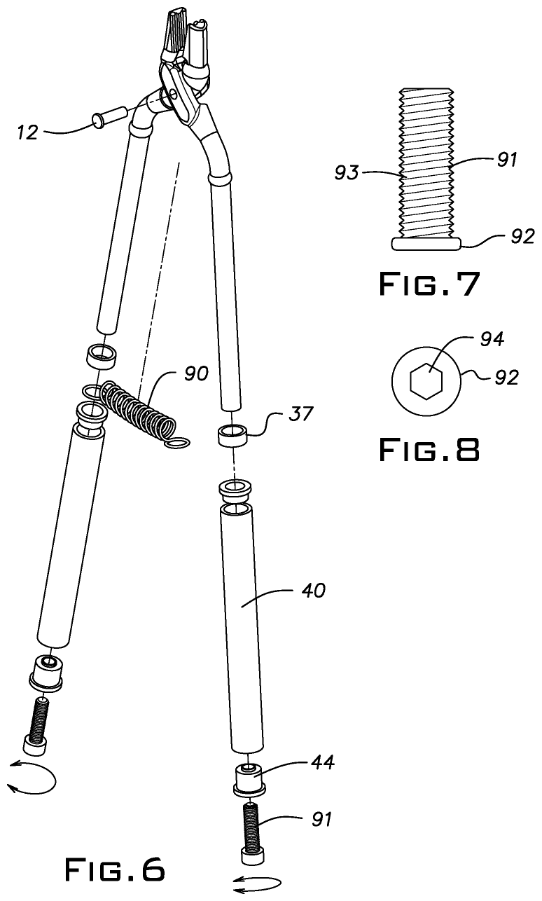

The head of the fastener 92 has a diameter substantially equivalent to the outer diameter of the first shaft 34 and the at least partially threaded shaft or pin 93 has a diameter that is less than the diameter of the head of the fastener and has a length that is less than the length of the first shaft, as illustrated in FIGS. 2 and 7. It is to be understood that the threaded bore 95 of first shaft 34 must have a length long enough to accommodate a sufficient length of the threaded shaft or pin 93 of the fastener 91 in order to provide the variable tension.

The head of the fastener 92 comprises a recess 94 in which a user inserts a tool, as illustrated in FIG. 8, that mateably fits the recess so that the tool can rotate the fastener to tighten or loosen the fastener of the tension system. The fastener 91 can be tightened such that the tension system is substantially infinitely adjustable to provide variable rates of rotation of the handle cover 40 in relation to the shaft upon application of different amounts of rotational force to the outer surface of the handle cover.

It is to be understood that the tool can be a screwdriver, wrench, drill bit, or socket adapted to fit a hex, flathead, Phillips or torx recess or the like in the fastener 91, as illustrated in FIG. 8.

The first handle cover 40 has a first handle cover stop 44, having an outer surface 97 adapted to abut the surface of the fastener 91 connected to the shaft. When the fastener 91 is tightened, the fastener presses the first handle cover stop outer surface 97 which presses the first handle cover stop 44 against the first shaft stop 37 as illustrated in FIG. 4.

The first handle cover 40 has a first handle cover stop 44 that is recessed within the first handle cover so that the full surface of the head of the fastener 91 is locatable flush or recessed within the first handle cover.

It should be understood that second embodiment of the tension system can also be readily applied to the second shaft of the hand-operated implement.

The tension system can be adjusted by the fastener 91 to operatively press a portion of the first handle cover 40 against the first shaft stop 37 to produce at least one of the at least three different amounts of force between the first shaft 34 and first handle cover 40.

For the avoidance of doubt, the devices and methods of the present invention encompass all possible combinations of the components, including various ranges of said components, disclosed herein. It is further noted that the term ‘comprising’ does not exclude the presence of other elements. However, it is also to be understood that a description of a product comprising certain components also discloses a product consisting of these components. Similarly, it is also to be understood that a description on a process comprising certain steps also discloses a process consisting of these steps.

In accordance with the patent statutes, the best mode and preferred embodiment have been set forth; the scope of the invention is not limited thereto, but rather by the scope of the attached claims.

What is claimed is:

1. A hand-operated implement with controllable hand grip rotation, comprising:
a first tool member pivotally connected to a second tool member via a pivot,
wherein the first tool member includes a first tool head at an upper end and a first handle at a lower end on an opposite side of the pivot,
wherein the second tool member includes a second tool head at an upper end and a second handle at a lower end on an opposite side of the pivot,
wherein the first handle includes a first shaft having a longitudinal length between a first upper end and a second lower end of the first shaft, a first handle cover, and a first tension system,
wherein the first handle cover has a longitudinal length and is disposed over at least a portion of the first shaft, and
wherein the first tension system operatively connects the first handle cover to the first shaft, with the tension system being adjustable to place at least three different amounts of force between the first shaft and the first handle cover such that the first handle cover can be either fixed against rotation or rotatable in relation to the first shaft upon application of a minimum amount of rotational force to the outer surface of the first handle cover.

2. The hand-operated implement according to claim 1, wherein a first shaft stop is present on the first shaft between the first upper end and the second lower end, wherein the tension system operatively presses a portion of the first handle cover against the first shaft stop to produce one of the at least three different amounts of force between the first shaft and the first handle cover.

3. The hand-operated implement according to claim 2, wherein the first shaft stop is located closer to the first lower end of the first shaft as compared to the second upper end.

4. The hand-operated implement according to claim 2, wherein the second lower end of the first shaft is threaded, wherein the tension system includes a nut, wherein the nut is adjustably connected to threads of the first shaft.

5. The hand-operated implement according to claim 4, wherein the first tension system further includes a washer disposed on the threaded part of the first shaft above the nut.

6. The hand-operated implement according to claim 5, wherein the first handle cover comprises a tube, wherein the first handle cover has a first upper end and a second lower end, and wherein the second lower end of the first handle cover extends past the second lower end of the first shaft.

7. The hand-operated implement according to claim 6, wherein a first handle cover stop is present on an inner surface of the tube and is in contact with the tension system.

8. The hand-operated implement according to claim 6, wherein the nut is located in a recess of the first handle cover, and wherein the nut is a lock nut.

9. The hand-operated implement according to claim 2, wherein the first shaft stop is cylindrical and has an outer diameter greater than a largest outer diameter of the first shaft.

10. The hand-operated implement according to claim 1, wherein the second handle includes a second shaft having a longitudinal length between a second upper end and a second lower end of the second draft, a second handle cover, and a second tension system,
wherein the second handle cover has a longitudinal length and is disposed over at least a portion of the second shaft, and
wherein the second tension system operatively connects the second handle cover to the second shaft, with the tension system being adjustable to place at least three different amounts of force between the second shaft and the second handle cover such that the second handle cover can be either fixed against rotation or rotatable in relation to the second shaft upon application of a minimum amount of rotational force to the outer surface of the second handle cover.

11. The hand-operated implement according to claim 10, wherein a second shaft stop is present on an outer surface of the second shaft between the second upper end and the second lower end, wherein the tension system presses a portion of the second handle cover against the second shaft stop to produce one of the at least three different amounts of force between the second shaft and the second handle cover.

12. The hand-operated implement according to claim 10, wherein each of the first handle cover and second handle cover one independently adjustable rotation-wise via the respective first and second tensioning systems.

13. The hand-operated implement according to claim 2, wherein the second lower end of the first shaft has a threaded bore, wherein the tension system includes a fastener, wherein the fastener is adjustably connected to the threaded bore of the first shaft.

14. The hand-operated implement according to claim 13, wherein the fastener comprises a head and at least a partially threaded shaft connected to the head, wherein the shaft fastener mateably connects via intermeshing threads with the threaded bore to operatively connect a first handle cover to the first shaft.

15. The hand-operated implement according to claim 14, wherein a face surface of the head of the fastener opposite a surface of the head connected to the shaft comprises a recess for a tool that mateably fits the recess so that the tool can rotate the fastener to tighten or loosen the fastener of the tension system, wherein the fastener can be tightened such that the tension system is substantially infinitely adjustable to provide variable rates of rotation of the handle cover or no rotation in relation to the shaft upon application of different amounts of rotational force to the outer surface of the handle cover.

16. The hand-operated implement according to claim 15, wherein the tension system can be adjusted by the fastener to operatively press a portion of the first handle cover against the first shaft stop to produce one of the at least three different amounts of force between the first shaft and first handle cover.

17. The hand-operated implement according to claim 16, wherein the first handle cover has a first handle cover stop having an outer surface adapted to abut the surface of the fastener connected to the shaft, and wherein when the fastener is tightened the fastener presses the first handle cover stop outer surface which presses the first handle cover against the first shaft stop.

18. The hand-operated implement according to claim 17, wherein the first handle cover stop is recessed within the first handle cover so that the face surface of the fastener it is locatable flush or recessed within the first handle cover.

19. A method for adjusting hand grip rotation on a hand-operated implement, comprising the steps of:
obtaining the hand-operated implement according to claim 1; and
adjusting the tension system to place a first amount of force between the first shaft and the first handle cover so that the first handle cover can be either fixed against rotation or rotatable in relation to the first shaft upon application of a first amount of rotational force to the outer surface of the first handle cover.

20. A kit, comprising:
the hand-operated implement according to claim 1, and
a key for adjusting the tension system.
